(19) United States
(12) Patent Application Publication
(10) Pub. No.: US 2022/0135386 A1
(43) Pub. Date: May 5, 2022

(54) Mounted Bottle Opener

(71) Applicant: Simpson Strong-Tie Company Inc., Pleasanton, CA (US)

(72) Inventor: Jin-Jie Lin, Livermore, CA (US)

(21) Appl. No.: 17/087,578

(22) Filed: Nov. 2, 2020

(51) Int. Cl. B67B 7/16

(52) U.S. Cl. CPC B67B 7/16

(57) ABSTRACT

A bracket to which a bottle opener and a receiving tray are attached mounted on an upright support surface. The bracket is preferably mounted to the support surface with one or more separate fasteners. The receiving tray attaches to the bracket below the bottle opener to catch the dislodged caps.

### BACKGROUND

This invention relates to a bracket having a bottle opener and a detachable receiver or tray incorporated therewith to receive the caps removed from bottles opened with the bottle opener, and to the shape and design of the receiving tray, the bottle opener, the bracket, and the bracket and the fasteners, and the decorative washers for attaching the bracket to an upright surface.

A bottle opener is typically used to remove a crimped cap from the mouth of a bottle. The caps closing the bottles are typically metallic caps having a depending rim that is crimped around an annular collar or rounded neck located at the opening of the bottle.

The bottle opener and cap receiver are of the type mounted on a bracket that is attached to a generally vertical or upright surface. The bottle opener is rigidly mounted to the bracket. To remove a cap from a bottle, the mouth or top of the bottle is positioned in the bottle opener with a point at the edge of the rim of the cap attached to the bottle set against a prying point or shoulder that is part of the bottle opener. The bottle is then pivoted or moved past the prying point to pry the cap from the bottle. As the bottle moves downward and past the prying point or shoulder, the movement of the cap is arrested by the prying shoulder and the cap is pulled or removed from the bottle.

A number of patents teach mounting a bottle opener to an upright surface and associating a tray, bag or other member with the bottle opener to catch the caps dislodged from the bottles that are opened. U.S. Pat. No. 1,684,285, granted in 1928 to J. H. McDonald, teaches having a receptacle for the caps that has a spring actuated cover for the receptacle. Great Britain Patent 296,593, granted in 1928 to Thomas Quinn, teaches a receptacle for the caps that has a trap door for emptying the receptacle. U.S. Pat. No. 2,029,804, granted in 1936 to F. E. Williamson teaches a retractable, spring-actuated chute for catching the dislodged caps and directing them to a basket. U.S. Pat. No. 2,649,004, granted in 1953 to H. B. Trimble, Sr. et al, teaches a receptacle with a spring-actuated, side panel for emptying the receptacle. U.S. Pat. No. 2,454,531, granted in 1948 to R. Van Trine, teaches placing an open, box-shaped receptacle on a ledge extending from the lower end of a bracket that incorporates the bottle-opener at the top of the bracket. U.S. Pat. No. 5,265,501, granted in 1993 to Gilbert Reyes, teaches using a bag as the receptacle. More recently, U.S. Design Pat. No. 802,388, granted to Paul A. Marcial in 2017, teaches a decorative bracket for a surface-mounted bottle opener, and U.S. Pat. No. 9,487,382, granted to Wicked Eye Products, LLC in 2016 teaches using a bracket having a bottle opener at is top and magnets located below the bottle opener to attract and arrest the dislodged caps so as to prevent them from falling to the ground.

The current invention improves upon the prior art by providing an attractive bottle opener and receptacle mounted on a bracket that is economical to manufacture and simple to use.

### SUMMARY OF THE INVENTION

The present invention provides a novel bracket to which a bottle opener and a receiving tray are attached with the bracket being mounted on a support surface. The bracket is preferably mounted to the support surface with one or more separate fasteners.

The present invention provides a novel tray that can attach to the bracket below the bottle opener to catch the dislodged caps.

In one form of the invention, the bottle opener is of metal formed out of the bracket which is itself formed from a single sheet of metal.

In one form of the invention, the detachable receptacle for the bottle caps is made from a single piece of sheet metal. The receptacle can be easily attached and removed from the bracket for emptying the bottle caps from the receptacle.

According to the present invention, the bracket has a generally planar main plate 2 that is attached to an upright or generally vertical surface. In one embodiment, a portion of the main plate 2 is bent out of the general plane of the plate 2 to form the cap dislodging members of the bottle opener. The cap dislodging members can also be formed separate from the bracket and attached thereto. The fasteners that attach the bottle opener to the bracket can also be used to attach the bracket to the upright member.

An object of the present invention is to provide a decorative bottle opener and receiving tray that is simple and easy to use.

An object of the present invention is to provide a decorative bottle opener and receiving tray that is economical in cost and easy to manufacture.

### DESCRIPTION OF THE DRAWINGS

FIG. 1 is a front perspective view of the present invention showing one embodiment of the bracket, one embodiment of a bottle opener formed from the bracket, one embodiment of the receiving tray attached to the bracket with the bracket being attached to an upright member, which as shown here is a typical square post, with fasteners and decorative washers being used to attach the bracket to the upright member. The decorative washer that can have structural functions in some embodiments looks like a hexagonal nut with a round, flat washer underneath the nut.

FIG. 2 is a front perspective view of the bracket, bottle opener, and receiving tray shown in FIG. 1. The fasteners shown in FIG. 1 to attach the bracket to the upright member are not shown. The decorative washers shown in FIG. 1 used with the fasteners are not shown. The bracket of the present invention can also be formed or made with a member that looks like the decorative washer shown in FIG. 1, and the fastener shown in FIG. 1 could be used to attach the bracket with the member that looks like a decorative washer to the upright member. The bracket of the present invention can also be formed or made with a member that looks like the decorative washer and head of the fastener shown in FIG. 1, and different fasteners can be used to attach the bracket to the upright member.

FIG. 3 is a front perspective view of the bracket and bottle opener shown in FIGS. 1 and 2.

FIG. 4 is a front view of the bracket and bottle opener shown in FIG. 3.

FIG. 5 is a back view of the bracket and bottle opener shown in FIG. 3.

FIG. 6 is a right side view of the bracket and bottle opener shown in FIG. 3.

FIG. 7 is a left side view of the bracket and bottle opener shown in FIG. 3

FIG. 8 is a top plan view of the bracket and bottle opener shown in FIG. 3.

FIG. 9 is a bottom plan view of the bracket and bottle openers shown in FIG. 3.

FIG. 10 is a front view of the bracket, bottle opener and receiving tray shown in FIG. 2.

FIG. 11 is a back view of the bracket, bottle opener and receiving tray shown in FIG. 2.

FIG. 12 is a right side view of the bracket, bottle opener and receiving tray shown in FIG. 2.

FIG. 13 is a left side view of the bracket, bottle opener and receiving tray shown in FIG. 2.

FIG. 14 is a top plan view of the bracket, bottle opener and receiving tray shown in FIG. 2.

FIG. 15 is a bottom plan view of the bracket, bottle opener and receiving tray shown in FIG. 2.

FIG. 16 is a front perspective view of one embodiment of the bracket, one embodiment of the bottle opener formed from the material of the bracket and one embodiment of the receive tray attached to the bracket. The bracket shown has a member that looks like the decorative washer and head of the fastener shown in FIG. 1.

FIG. 17 is a front perspective view of the receiving tray shown in FIGS. 1 and 2.

FIG. 18 is front view of the receiving tray shown in FIG. 17.

FIG. 19 is a back view of the receiving tray shown in FIG. 17.

FIG. 20 is right side view of the receiving tray shown in FIG. 17.

FIG. 21 is a left side view of the receiving tray shown in FIG. 17.

FIG. 22 is top plan view of the receiving tray shown in FIG. 17.

FIG. 23 is bottom plan view of the receiving tray shown in FIG. 17.

FIG. 24 is front perspective, exploded view of one embodiment of the bracket of the present invention. One embodiment of fasteners used to connect a bottle opener to the bracket and to connect the bracket to the upright are shown.

FIG. 25 is a front view of a bracket, bottle opener, receiving tray and fasteners used to connect the bottle opener to the bracket and to connect the bracket to an upright member. The bracket is shown attached to an upright member. The bracket is formed with a member that looks like a decorative washer with the head of a fastener received in the decorative washer. The member is formed so that the portion that looks like the head of a fastener has a recess that looks like a drive recess for driving a fastener.

FIG. 26 is a top perspective view of a decorative washer that can be used with the bracket of the invention.

FIG. 27 is an exploded, perspective view of a decorative washer and fastener that can be used with the bracket of the invention.

FIG. 28 is an exploded, perspective view of a decorative washer and fastener that can be used with the bracket o the invention. The fastener is partially received in the decorative washer.

FIG. 29 is a top perspective view of a decorative washer and fastener that can be used with the bracket of the invention. The fastener is shown with the head of the fastener shown fully received in the decorative washer with the shank of the fastener protruding from the bottom of the decorative washer.

### DETAILED DESCRIPTION OF THE INVENTION

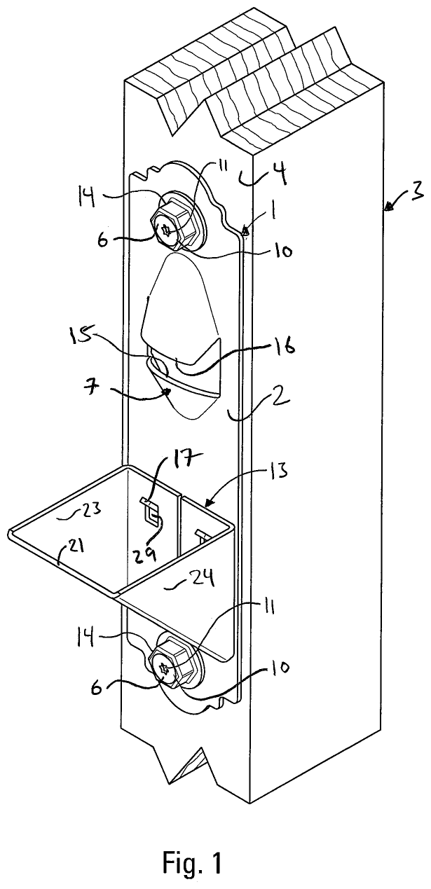

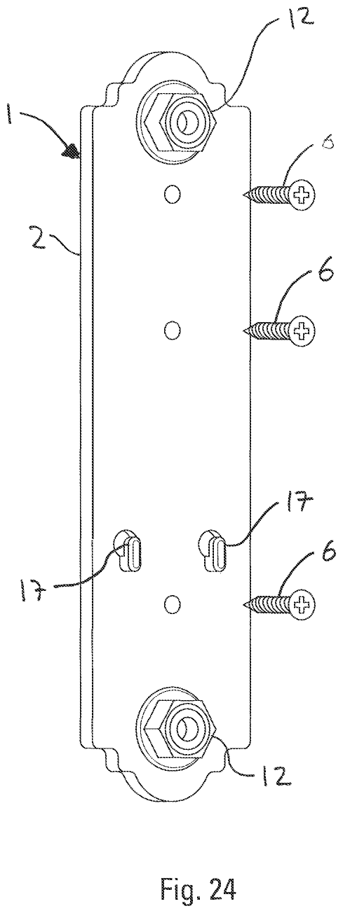

As shown in FIG. 1, in the preferred embodiment, the bracket 1 has a main plate 2 that is attached to an upright 3 with a generally vertical surface 4. The bracket 1 is preferably constructed from sheet metal, and the main plate 2 can be generally planar. The generally planar main plate 2 can be embossed with decorative elements. The main plate 2 can also be formed with decorative bends, so that the main plate 2 is not generally planar. The main plate 2 can also be provided with contours or bends to conform to a non-planar attachment surface. The main plate 2 can have an outline or edge that is simple or decorative in shape. The top and bottom ends of the plate 2 shown in FIG. 1 have decorative contouring. As shown in FIG. 24, the main plate 2 can be also be formed with or have ornamentation added to it.

FIG. 24 is front perspective, exploded view of one embodiment of the bracket 1 of the present invention. In FIG. 24, the fasteners 6 used to connect a bottle opener 7 to the bracket 1 and to connect the bracket 1 to the upright 3 are shown aligned with openings 8 in the bracket 1 for receiving the fasteners 7. The fasteners shown are simple threaded members having a shank 9, a flared head 10 and the flared head has a tool receiving inset 11 for driving the fastener into the upright member 3. The bracket 1 shown in FIG. 24 is also formed with members 12 that look like decorative washes at its top and bottom ends. The members 12 that look like decorative washers have openings 8 that can receive additional fasteners.

FIG. 1 is a front perspective view of the present invention showing one embodiment of the bracket 1, one embodiment of a bottle opener formed from the bracket 1, one embodiment of the receiving tray 13 attached to the bracket 1 with the bracket 1 being attached to an upright member 3, which as shown here is a typical square post, with fasteners and decorative washers 14 being used to attach the bracket 1 to the upright member 3. The decorative washer 14 can also have structural functions in some embodiments, and as shown in FIG. 1, looks like a hexagonal nut with a round, flat washer underneath the nut.

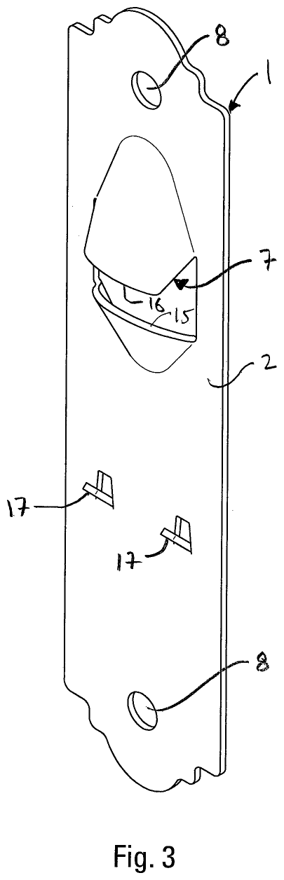

As shown in FIG. 3, in the preferred embodiment, below the cap dislodging members 15 and 16 of the bottle opener the main plate 2 is provided with one or more retaining flanges 17 to support the receiving tray. The retaining flanges 17 are cut and bent from the body of the main plate 2 and extend upwardly at an acute angle to the main plate 2.

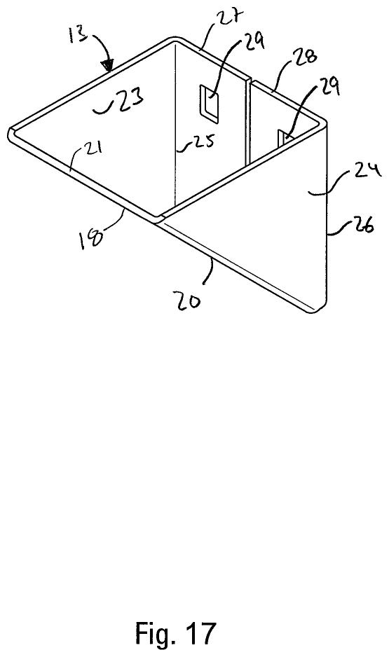

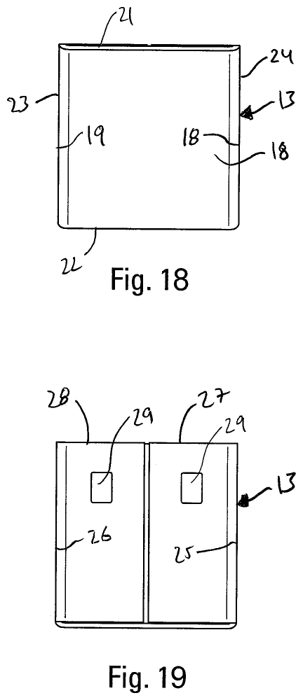

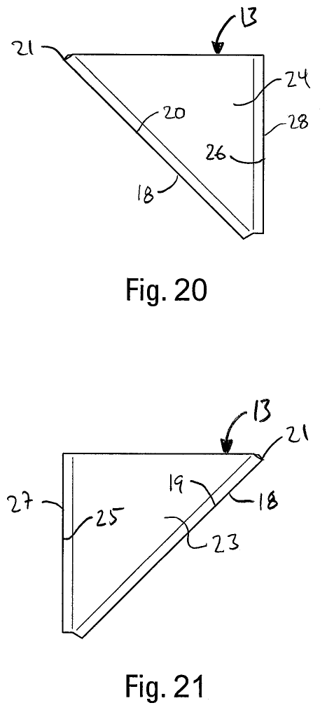

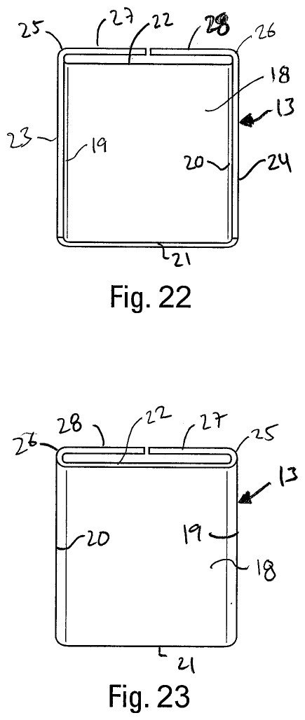

As shown in FIGS. 17-23, the receiving tray is formed from a single-piece of sheet metal bent to form a receiving tray. The receiving tray is preferably formed with a catching wall 18 having two generally opposed first and second side edges 19 and 20. Preferably, the catching wall 18 is a generally planar member that extends between the two opposed first and second parallel side edges 19 and 20. In the preferred embodiment, the catching wall 18 also extends between a top edge 21 and a bottom edge 22 that is disposed generally opposite and parallel to the top edge 21. In the preferred embodiment the catching wall 18 is a generally rectangular member as defined by the first and second side edges 19 and 20 and the top and bottom edges 21 and 22. In the preferred embodiment, the catching wall 18 is a thin planar member made from sheet metal.

As is also shown in FIG. 1, the receiving tray 13 is preferably formed with first and second side members 23 and 24 extending orthogonally from the first and second side edges 19 and 20 of the catching wall 18. The side members 23 and 24 are preferably triangular in shape and are preferably thin planar members. Each side member preferably has a lateral side edge 25 and 26 respectively. Preferably, first and second facing members 27 and 28 are attached to the first and second side members 23 and 24 respectively at the lateral side edges 25 and 26 of the side members 23 and 24. Preferably, each facing member 27 or 28 is disposed orthogonally to the side member 23 or 24 to which it is attached, the facing members 27 and 28 are thin, generally planar members and the facing members 27 and 28 are aligned in a single plane.

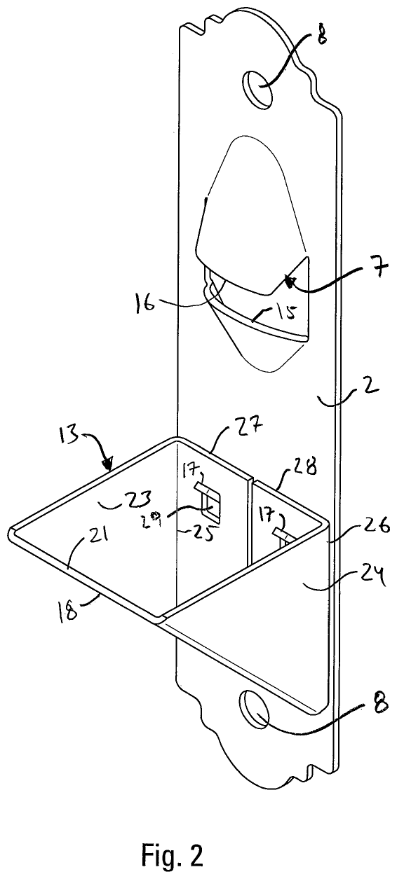

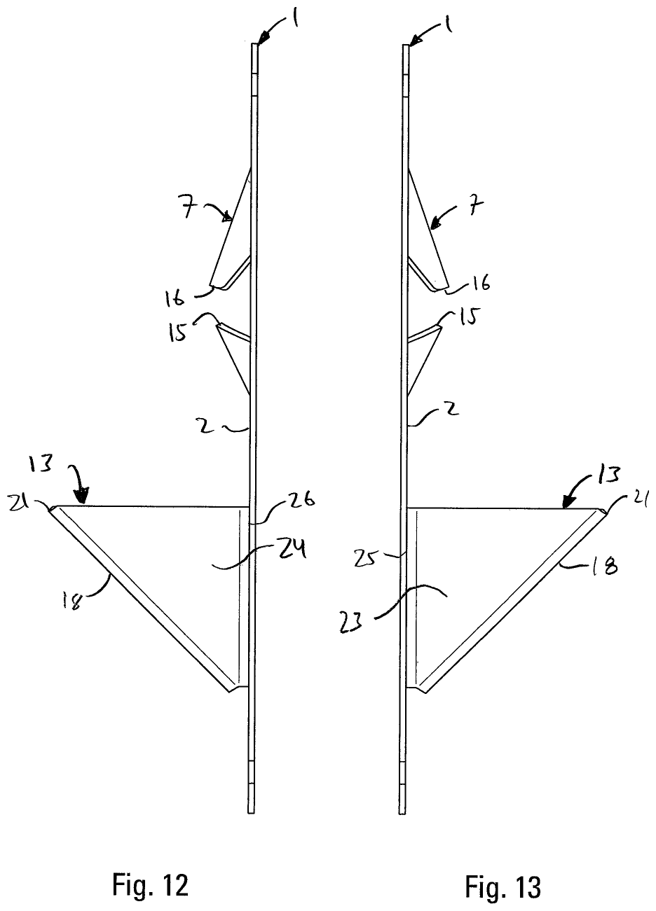

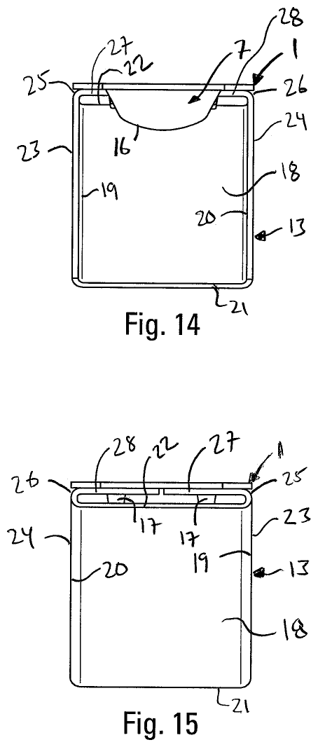

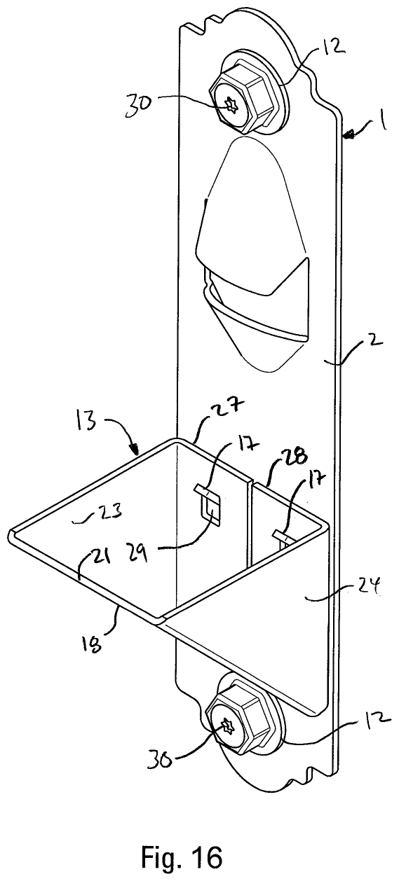

Preferably, the first and second facing members 27 and 28 are each formed with an opening 29 for receiving a retaining flange 17 formed on the main plate 2. As shown in FIGS. 2, and 12-15, the first and second facing member 27 and 28 are generally planar and interface with the generally planar main plate.

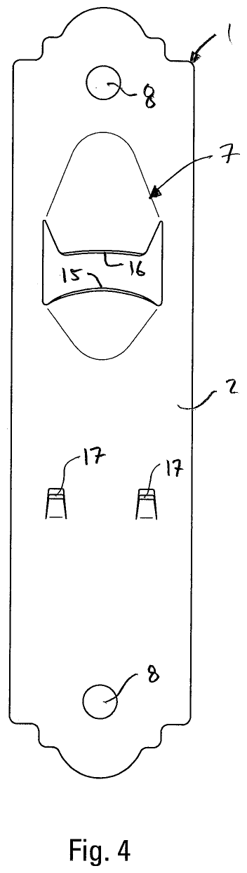

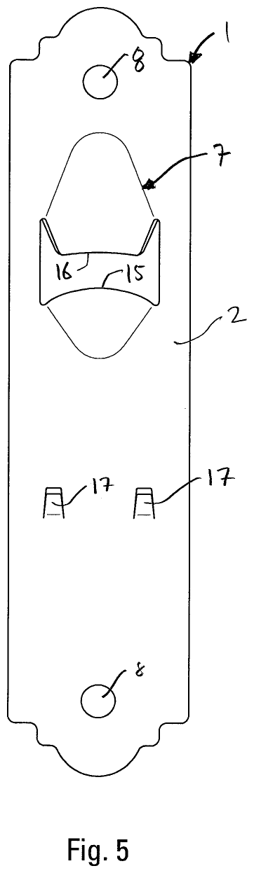

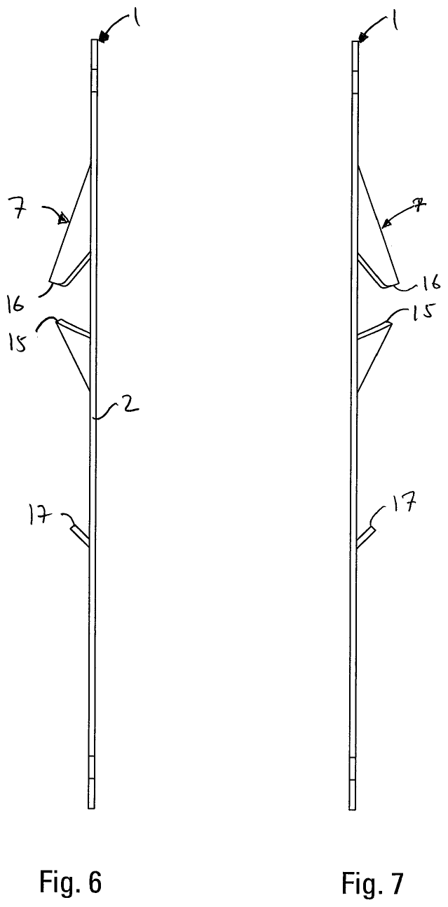

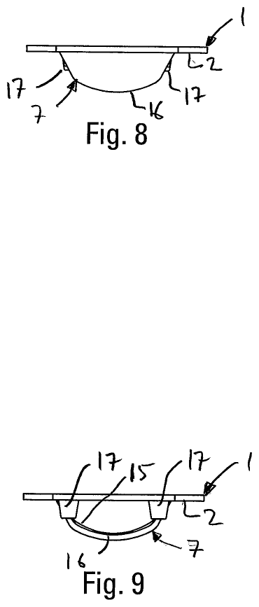

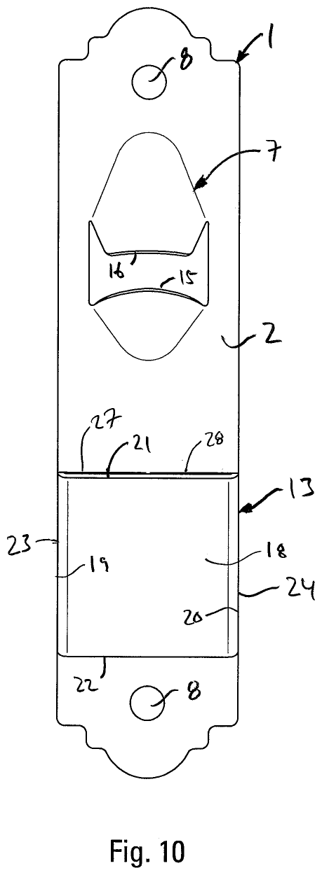

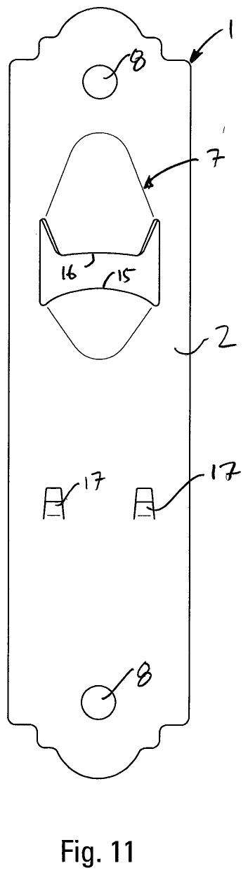

As shown in FIGS. 3, 4 and 5, preferably the cap dislodging member includes a cap edge engaging shoulder 15 which is used to pry the cap off the bottle. Preferably, the cap dislodging member also has a bracing member 16 oppositely disposed from the cap engaging shoulder 15 that will engage the top surface of the cap away from point on the rim of the cap where the cap engages the cap edge engaging shoulder 15 so as to direct movement of the bottle and thus help concentrate the prying force provided by the cap edge engaging shoulder 15.

As shown in FIGS. 1, and 24-29, preferably, the bracket 1 is secured to the support surface by screws or other fasteners 6.

As shown in FIGS. 1, 26-29, in one form of the invention, the fasteners are separate screws 6 used with decorative washers 14 as taught by U.S. Pat. No. 10,253,801, the contents of which is incorporated herein by reference.

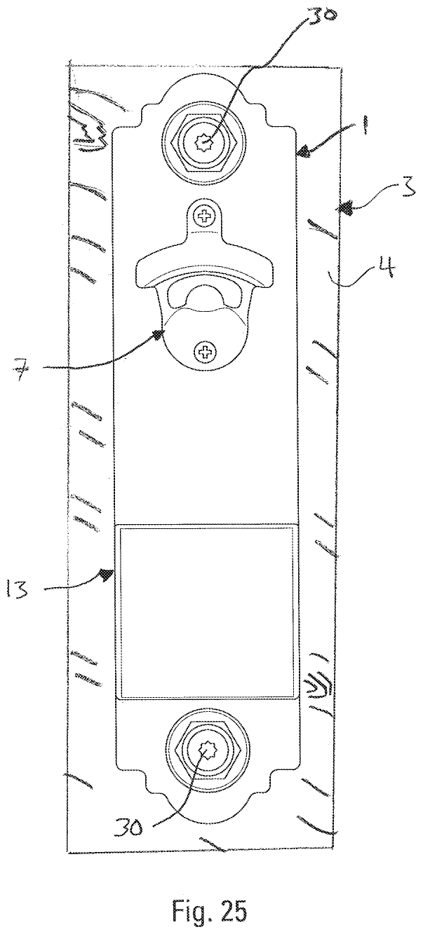

FIG. 25 is a front view of a bracket 1, bottle opener 7, receiving tray 13 and fasteners 6 used to connect the bottle opener to the bracket 1 and to connect the bracket 1 to an upright member 3. The bracket 1 is shown attached to an upright member 3. The bracket 1 is formed with a member 12 that looks like a decorative washer with the head of a fastener received in the decorative washer. The member 12 is formed so that the portion that looks like the head of a fastener has a recess 30 that looks like a drive recess for driving a fastener.

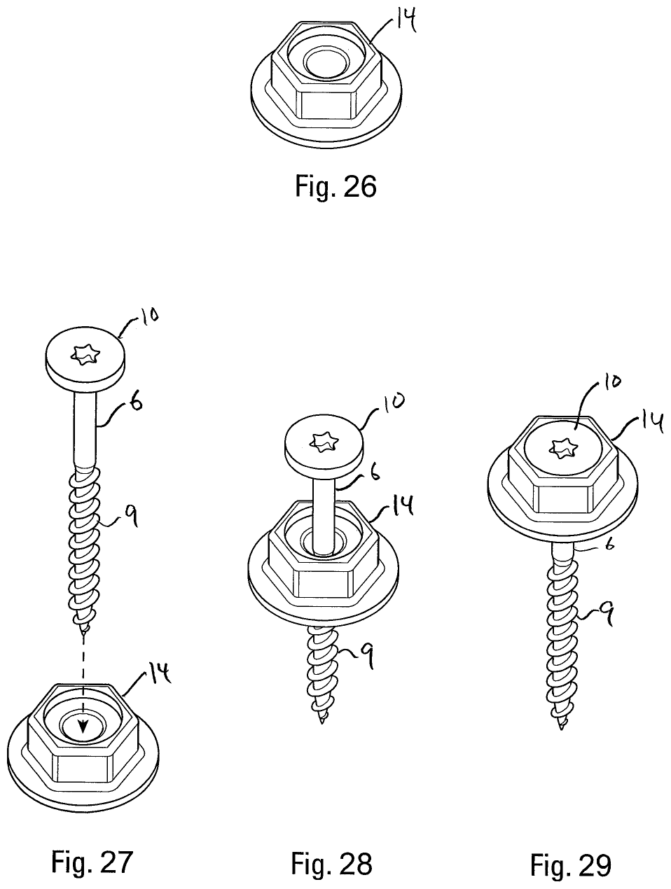

FIG. 26 is a top perspective view of a decorative washer 14 that can be used with the bracket 1 of the invention.

FIG. 27 is an exploded, perspective view of a decorative washer 14 and fastener 6 that can be used with the bracket 1 of the invention.

FIG. 28 is an exploded, perspective view of a decorative washer 14 and fastener 6 that can be used with the bracket 1 of the invention. The fastener 6 is partially received in the decorative washer 14.

FIG. 29 is a top perspective view of a decorative washer 14 and fastener 6 that can be used with the bracket 1 of the invention. The fastener 6 is shown with the head 10 of the fastener 6 shown fully received in the decorative washer 14 with the shank 9 of the fastener 6 protruding from the bottom of the decorative washer 14.

We claim:

1. An apparatus for dislodging crimped caps from bottles, the apparatus comprising:
a. an upright member having a mounting surface;
a bracket attached to the mounting surface;
b. a bottle opener for dislodging the crimped caps, the bottle opener being attached to the bracket;
c. a receive tray attached to the bracket below the bottle opener, the receiving tray having a catching wall 18 having two generally opposed first and second side edges, the catching wall being a member that extends between the two opposed first and second side edges, the catching wall also extends between a top edge and a bottom edge that is disposed generally opposite to the top edge, the receiving tray also having first and second side members extending orthogonally from the first and second side edges of the catching wall, each side member having a lateral side edge with first and second facing members attached to the first and second side members respectively at the lateral side edges of the side members, and each facing member is disposed orthogonally to the side member to which it is attached and the facing members are aligned in a single plane.
